(19) United States
(12) Patent Application Publication
(10) Pub. No.: US 2014/0049553 A1
(43) Pub. Date: Feb. 20, 2014

(54) STORAGE MODULE, IDENTIFICATION AND DEPLOYMENT OF EDITABLE GRAPHICAL INFORMATION

(71) Applicants: Luis Ivan Ortega CAÑEDO, (US); AWARENESS CARD S.A.P.I. DE C.V., Santa Maria la Ribera (MX)

(72) Inventor: Roberto Alarcon ALFARO, Santa Maria la Ribera (MX)

(73) Assignees: AWARENESS CARD S.A.P.I. DE C.V., Santa Maria la Ribera (MX); Luis Ivan Ortega CAÑEDO, Santa Maria la Ribera (MX)

(21) Appl. No.: 13/965,878

(22) Filed: Aug. 13, 2013

Related U.S. Application Data
(60) Provisional application No. 61/683,068, filed on Aug. 14, 2012.

(51) Int. Cl. G06F 1/32; G06T 1/00

(52) U.S. Cl. CPC G06F 1/32; G06T 1/00
USPC 345/581

(57) ABSTRACT

The invention relates to a graphic communication and radio frequency (RF) communication device which is a multipurpose identification module that stores and displays graphic information through an integrated display, renews and maintains the graphical information until the next exposure to the external “reader/writer” module. It can refer to data stored in memory and complements configured according to the use, situation or environment of the location and purpose of the reader/writer, such as advertising or information relevant to the environment and/or location, among other cases.

### TECHNICAL FIELD

The described technology refers to a portable storage and display of static graphical digital content device. After the image is changed or refreshed, the screen keeps it without consuming more energy. The transfer of data and commands is through RF.

### BACKGROUND

In the prior art, there are multiple systems that describe deployment of graphical information such as in the communication system and terminal module described in patent U.S. 2006/0267769 A1 and JP 2005-158229 it is described a system of supply of information on demand for a user in a specific area, without the operation of a device. The graphical information displayed on the display is active only while it is in the range of the induction antenna (described in embodiment 3). It is also conceived a design in which there is no power supply described in the embodiment 2, however because it doesn't have a power supply, only displays information within the range of the reader/writer. Another example is the system for multi-application smart card described in patent U.S. 2006/0065741 A1, in which applications are stored in the card. In addition it uses a firewall and an operating system. In the display module of price information described in the prior art document “Electronic Ink+RFID price tags” from Epson Corporate obtained from the webpage “Gizmodo” described on the following hyperlink http://gizmodo.com/026090/epsons-electronic-ink-%252B-rfid--21st-century-price-tags and the display module of price information described in the document “UPM Ella Store Labels” obtained from the webpage “High Technology Finland” described on the following hyperlink http://www.htf.fi/direct.aspx?area=htf&prm1=685&prm2=article the system does not require a rewritable memory, it is only identified with the reader/writer and the commands are sent to be displayed on the electronic label blackboards. In the module to display balance information to pay tolls described in the document “FastTrax” from “Axis Design Inc” obtained from the webpage “e Ink” described in the following hyperlink: http://www.eink.com/concept_showcase_FastTrax.htm the module displays only alpha numeric information on segmented display. Therefore, there is a need to solve the deficiencies of the systems that display graphical information of the prior art in order to display not only alpha numeric data but also graphic images such as pictures. Being capable to keep information on the display when it is out of the range of the reader/writer, to have the ability to read the information previously uploaded without being on a specific area but anywhere. To have the ability to receive information on a portable device different from cellular phones, smartphones, tablets, portable videogames console, smart watches or similar without the need to operate something and even without the need of having any technical skills and or knowledge. The present invention solves those deficiencies by providing a matrix screen capable of displaying complex images such as pictures and not only alphanumeric information. Using display technologies of ultra-low energy consumption such as “electronic ink” the system will be capable to keep the image in the display after being uploaded, without the need of being next to the writer/reader all the time or being on a specific area permanently. So the user will be capable of carrying the device and read the information at any time without having the risk of losing the image until the next exposure to a reader/writer when the image changes (if the system is configured to do so). As being only a graphic display information device, no operation is required to use it, the user only needs to read it just as a traditional paper, no technology skill is required to do so. The user only needs to expose the device to the range of the reader/writer to refresh the information, no further operation is required to read the information on the display.

### DESCRIPTION OF THE INVENTION

It is described a portable storage and display of static graphical digital content device. The device is capable to keep information on the display when out of the range of the reader/writer, to have the ability to read the information previously uploaded without being on a specific area but anywhere. The device is capable of receiving information on a portable device different from cellular phones, smartphones, tablets, portable videogames console, smart watches or similar without the need to operate something and even without the need of having any technical skills and/or knowledge. The device provides a matrix screen capable of displaying complex images such as pictures and not only alphanumeric information. The device uses display technologies of ultra-low energy consumption such as “electronic ink”. The system is capable to keep the image in the display after being uploaded, without the need of being close to the writer/reader all the time or being on a specific area permanently. So the user is capable of carrying the device and reading the information at any time without having the risk of losing the image until the next exposure to a reader/writer when the image changes (if the system is configured to do so). The device comprises a read-only memory that contains a unique identification code, which serves to refer it in a database previously loaded or to activate certain predefined functions, depending on the application. The exchange of data and powering of the module with the reader/writer is performed using wireless technologies such as RFID, NFC, etc. The determination of the information to be exchanged is configured on the host and the device receives the instruction and displays and exchanges such information according to established parameters. The device includes a rewritable memory whose function is to store information related to the application used, and depending on this, it is assigned a portion of the total memory. Some of the stored content in the memory is displayed on the screen depending on the command sent via RF reader/writer, similar how the RFID standard works. The screen has the ability to deploy and retain information, even without using the power source constantly, such as the concept of “electronic ink” which results in the reading of graphic information in any location no matter if it is not within the range of the RF reader/writer. The main function of the screen is to display information about the last time the device was activated. It can refer to data stored in memory and complements configured according to the use, situation or environment of the location and purpose of the reader/writer, such as advertising or information relevant to the environment. For example, if used as a payment method on a public transportation system, it could display information related to the remaining balance of the service and/or information of the station's surrounding in which was used. Another example would be to use the device as a car ignition module, in which you can display information related to the maintenance of the car. These examples does not limit its use. The information it is not conditioned to a specific role of the user or the context that is generated with the system. The format of this device is not conditioned in the form of a card.

### BRIEF DESCRIPTION OF THE FIGURES

FIG. 1 shows all the electronic components of the device.

FIG. 2 shows the interaction of the device with external elements to it.

### DETAILED DESCRIPTION OF INVENTION

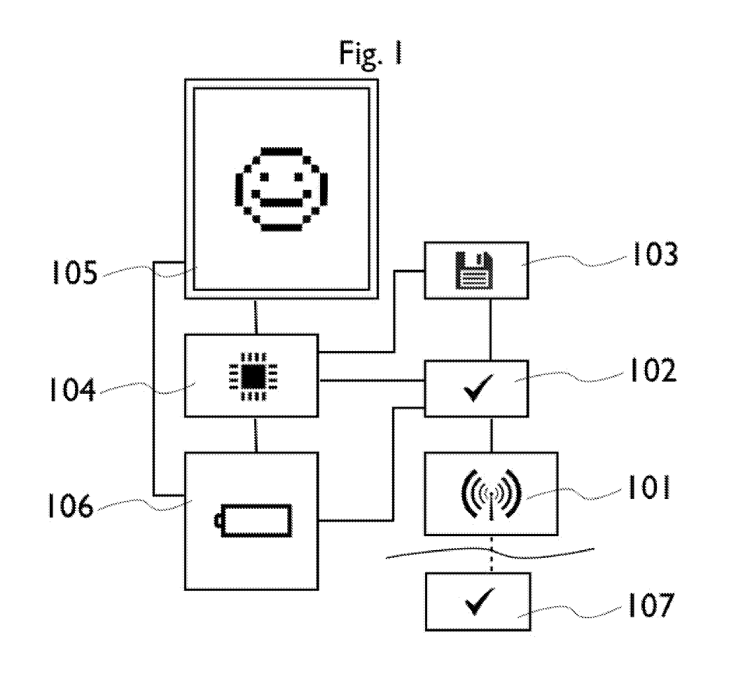

FIG. 1 is a block view of the minimum system elements. The antenna (101) is responsible of receiving and sending information via radio frequency RF. The RF transducer (102) is responsible for coding and decoding the information and determining which card's elements will be activated, depending on whether it is in read or read/write mode. The memory (103) is responsible for storing information and images. The control system (104) is responsible for decoding the images and send them to the screen (105) as well as to store the information on the memory (103). The elements 104 and 105 are powered by a battery (106). The secondary RF system (107) corresponds to a different nomenclature for known standards and can be extended according to the secondary application. FIG. 1 shows the antenna (101) that receives induction. The induction starts the transducer RF module (102) which transmits its ID code. The EXTERNAL module RF Reader/Writer validates the code and transmits the commands. These could be “Change the display information” or “load data to the memory.” The battery (106) is always activated when receiving either of the two commands of the RF transducer (102), which are “Change the display information” or “load data to the memory.” In order to know which process or data will be loaded in the device (201), the first step is to identify the device (201) with the reader/writer (202). When the device (201) is exposed to the induction range of the reader/writer (202), the first process is to access the memory (103) and then send the ID file stored in it and send it to the reader/writer (202) which sends the ID to the remote or local server (203) and compares it with the database (204) in which it is stored the information, such as but not limited to “access granted”, “balance of the service” among others. The database (204) also stores the graphic information to be sent to the device (201) and any other command to be configured according to the specific reader/writer (202) which interacts with the device (201).

Process “Load Data to the Memory”

Once the battery (106) is activated, the transducer sends the command “load data to the memory” to the control system (104) which stores information in the memory (103). At the end of the process, the control system (104) turns off the battery (106).

Process “Change the Display Information”

Once the battery (106) is activated, the transducer sends the command “change the display information” to the control system (104) which extracts information from the memory (103), it is decoded by the same control system (104) and sends it to the display (105). At the end of the process the control system (104) turns off the battery (106).

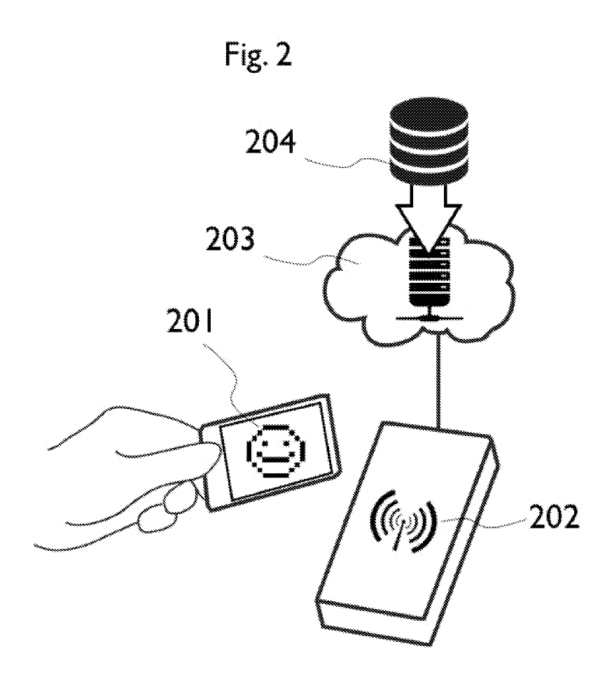

The card may have a RF dual system (optional), a secondary transducer (107) is implemented. The secondary transducer may or may not be integrated as an alternative system to the card. This system has its own elements of the alternate function and does not interfere with our system. FIG. 2 shows the external elements and how they interact with the device described in FIG. 1. The element 201 contains all the elements described in FIG. 1. The element 201 is exemplified with a card format but is not limited either in shape or size to this. The interaction of the device (201) with a RF reader/writer (202), in example as an RFID format, the device (201) is approached within the range of induction/transmission of the reader/writer (202) which activates the device (201). Once activated, the reader/writer RF (202) transmits the command “load data to the memory” or “change the display information” and starts the process described in FIG. 1. The RF reader/writer (202) can be configured in a dual format, which means this module can send two different encodings, and in the case of device 201 activates the secondary transducer element (107) with an independent process and does not interfere with the commands “load data to the memory” or “change the display information.” Element 202 is controlled by either a local or a remote server (203), which is responsible of processing the identification code transmitted by the transducer (102) and, based on the required process transmits the command and/or necessary information to the device (201).

1-A graphic communication and radio frequency (RF) communication device that displays information on its integrated display comprising:
an external read/write module;
a database;
an RF transducer to encode/decode commands received by the external read/write module;
one internal memory to store information, wherein the device carries out two processes: receiving information from the reading/writing module to keep it in its internal memory and changes information in its integrated display, wherein the processes are carried out through RF commands.

2. The graphical communication device according to claim 1, further comprising an encoding mechanism which allows to know which command to execute, this information changes each time the device is in the range of induction/communication of the read/write module.

3. The graphical communication device according to claim 1, further comprising a Radio Frequency (RF) single or dual communication mode.

4. The graphical communication device according to claim 1, further comprising an antenna for communication between the device and the external RF read/write module.

5. The graphical communication device according to claim 1, further comprising a microcontroller that executes the commands decoded by the RF transducer module.

6. The graphical communication device according to claim 1, wherein the device displays information in an integrated display.

7. The graphic communication device according to claim 6, wherein the device only consumes power from the battery when changing the display information.

8. The graphic communication device according to claim 6, wherein the device consumes power from the battery when charging information in the memory.

9. The graphic communication device according to claim 6, wherein the device retains the information displayed without consuming energy.

10. The graphical communication device according to claim 1, further comprising a power supply.

11. The graphical communication device according to claim 9, wherein the power supply may be a battery.

12. The graphical communication device according to claim 1, further comprising an RF transducer capable of encoding and decoding commands.
